(19) United States
(12) Patent Application Publication
(10) Pub. No.: US 2011/0254775 A1
(43) Pub. Date: Oct. 20, 2011

(54) KEYBOARD WITH LIGHTING SOURCE

(75) Inventor: FONG CHI HSU, Chung Ho City (TW)

(73) Assignee: JENSIN INTERNATIONAL TECHNOLOGY CORPORATION, Chung Ho City (TW)

(21) Appl. No.: 12/838,481

(22) Filed: Jul. 18, 2010

(30) Foreign Application Priority Data
Apr. 16, 2010 (TW) 099111989

(51) Int. Cl. G06F 3/02

(52) U.S. Cl. 345/170

(57) ABSTRACT

A keyboard with lighting source provides two conductive sheets made of copper foil, tin foil or aluminum foil as electrodes of semiconductor light emitting components. Multiple through holes are provided at the upper conductive sheet electrode. The semiconductor light emitting components are attached to and connected to the lower conductive sheet electrode at the areas exposing from the through holes and the upper conductive sheet electrode at the areas near the through holes. No light guide plate or printed circuit board with complicated layout is necessary to meet the required features such as thinness, uniform luminance, and simplicities of structure and fabricating process.

### BACKGROUND OF THE INVENTION

1. Field of the Invention

The present invention is related to a keyboard and particularly to a keyboard with lighting source.

2. Brief Description of the Related Art

The desktop computer and laptop computer have been become indispensable necessities in our lives along with the progress of the computer technology. As for the keyboard, it is the most important input device for being operated by the user to key in instructions and data till now in spite of what type computer being used. Hence, the keyboard is irreplaceable although the input peripherals of the computer are diversified in the modern society.

Because the irreplaceability of the keyboard in the field of computer application, development of the keyboard is closely related to convenience for operation of the user. In order to be able to use the keyboard at a place with insufficient light, a keyboard with lighting source is emerged. Moreover, in order to meet user's need regarding thinness, uniform brightness, and simplicities of structure and fabrication process, Taiwan Utility model Nos. M324816, M347618 and M366176 disclose several different keyboard structures. However, the preceding references have deficiencies in thinness, uniform brightness, and simplicities of structure and fabrication process.

### SUMMARY OF THE INVENTION

Accordingly, an object of the present invention is to provide a keyboard with lighting source which provides a structure of keyboard capable of fulfill the features of thinness, uniform brightness, and simplicities of structure and fabrication process.

In order to achieve the preceding object, the keyboard with lighting source according to the present invention comprises a button key circuit set, a lower conductive sheet electrode, an upper conductive sheet electrode, and multiple semiconductor light emitting components. Wherein the upper conductive sheet electrode is disposed between the button key circuit set and the lower conductive sheet electrode, and the upper conductive sheet electrode provides an insulation layer to isolate the lower conductive sheet electrode and multiple through holes passing through the insulation layer; the semiconductor light emitting components are attached to and electrically connected to the lower conductive sheet electrode at areas exposed via the through holes, and are attached to and electrically connected to the upper conductive sheet electrode at areas next to the through holes.

In a preferred embodiment, the upper conductive sheet electrode of the keyboard with lighting source is a foil made of copper, tin or aluminum attached with the insulation layer, and the lower conductive sheet electrode is a bottom plate made of metal.

In a preferred embodiment, the upper conductive sheet electrode of the keyboard with lighting source is a foil made of copper, tin or aluminum and is attached with the insulation layer, the lower conductive sheet electrode is a foil made of copper, tin or aluminum, and a bottom plate is disposed at a side of the lower conductive sheet electrode apart from the upper conductive sheet electrode.

In a preferred embodiment, the button key circuit set further comprises a film circuit board, multiple pivotal scissors and multiple key caps, wherein the film circuit board is disposed next to the upper conductive sheet electrode, having multiple sensing electrode pairs and multiple elastic press buttons corresponding to the sensing electrode pairs; the pivotal scissors has an end pivotally connect with the bottom plate, being disposed at circumferences of the elastic press buttons respectively; multiple key caps connect with another end of the respective scissor, being disposed on the elastic press buttons respectively.

In a preferred embodiment, the through holes of the keyboard with lighting source are disposed at the peripheries of the sensing electrode pairs respectively.

In a preferred embodiment, the semiconductor light emitting components of the keyboard with lighting source are light emitting diodes.

Accordingly, the keyboard with lighting source according to the present invention provides semiconductor light emitting components which act as the luminance source to be attached to and electrically connected to the upper conductive sheet electrode and the lower conductive sheet electrode which is made of copper foil, tin foil or aluminum foil with through holes instead of the light guide plate or the printed circuit board with complicated layout; therefore, the required features such as thinness, uniform brightness, and simplicities of structure and fabrication process can be meet substantively. Especially, the metal bottom plate of the keyboard can be acted as the lower conductive sheet electrode directly to omit a conductive sheet such that the demand of thinned keyboard and simplicities of structure and fabrication process are fulfilled effectively.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a disassembled perspective view of the first embodiment of a keyboard with lighting source according to the present invention;

FIG. 2 is an exploded perspective view illustrating a single key of the keyboard shown in FIG. 1;

FIG. 3 is a sectional view of the single key of the keyboard shown in FIG. 1;

FIG. 4 is a disassembled perspective view of the second embodiment of a keyboard with lighting source according to the present invention;

FIG. 5 is an exploded perspective view illustrating a single key of the keyboard shown in FIG. 4;

FIG. 6 is a sectional view of the single key of the keyboard shown in FIG. 4.

### DETAILED DESCRIPTION OF THE INVENTION

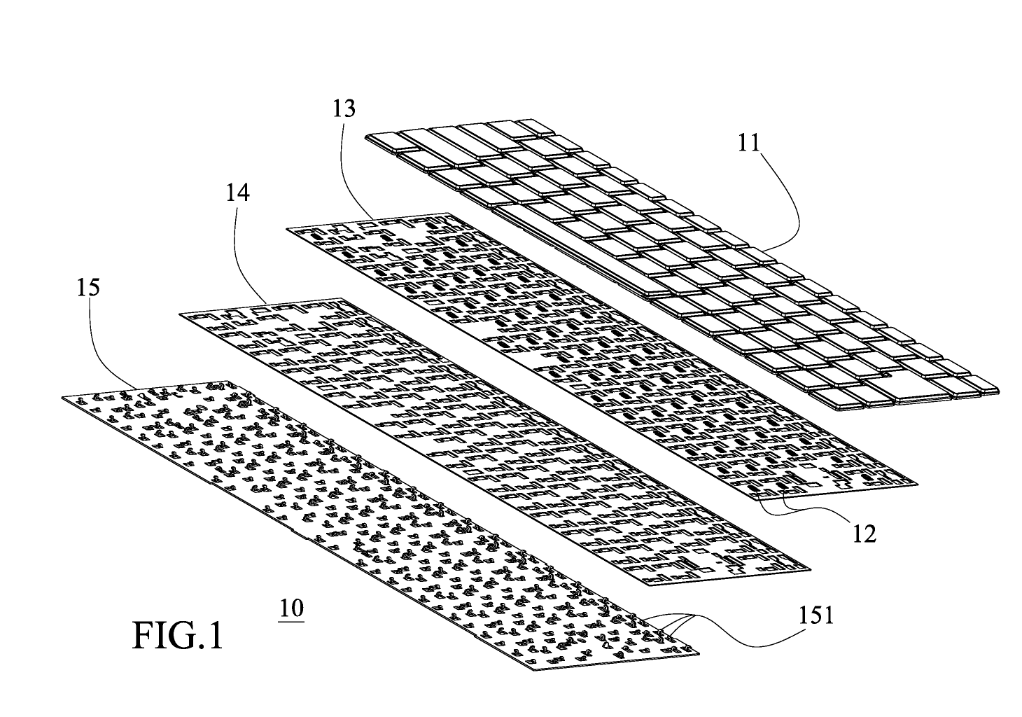

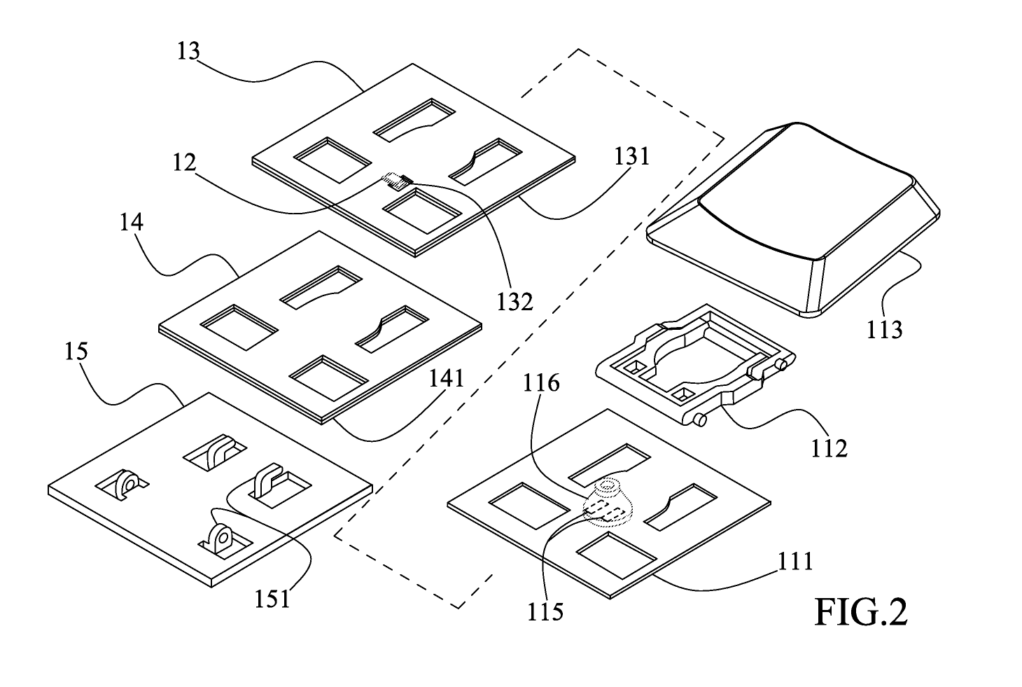

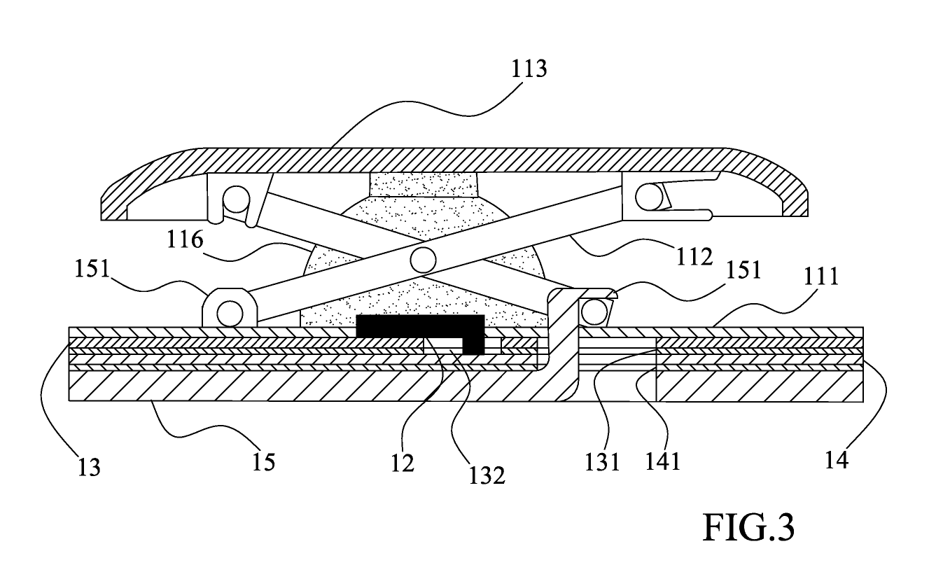

Referring to FIGS. 1 to 3, the first embodiment of a keyboard with lighting source according to the present invention is illustrated. The keyboard 10 comprises a button key circuit set 11, multiple semiconductor light emitting components 12 such as the light emitting diodes (LED), an upper conductive sheet electrode 13, a lower conductive sheet electrode 14, and a bottom plate 15.

The bottom plate 15 is made of metallic material or non-metallic material with better stiffness such as hard plastics for supporting the entire keyboard 10. There are multiple supporting posts 151 at the upper side of the bottom plate 15, and holes are provided at the lower conductive sheet electrode 14 and the upper conductive sheet electrode 13 corresponding to the supporting posts 151 for the supporting posts 151 passing through the holes to secure the button key circuit set 11 to the top side of the upper conductive sheet electrode 13.

The button key circuit set 11 is primarily employed to detect the key pressed by a user and convert the detected result to a standard key signal which is then transmitted to a computer connected to the button key circuit set 11 such that the button key circuit set 11 acts as an input interface at the time of instructions or data being keyed in by the user. Therefore, the elements in the button key circuit set 11 has a film circuit board 111, multiple scissors 112 and multiple key-caps 113 in addition to an integrated circuit (not shown) which is built-in or external for converting to and transmitting the standard keyboard signals.

The film circuit board 111 is disposed next to the upper conductive sheet electrode 13 and provides multiple pairs of sensing electrodes 115 and multiple elastic press buttons 116 which are disposed on top of the sensing electrode pairs 115 correspondingly. The elastic press buttons 116 are surrounded and fit with the scissors 112 which have an end connecting with the supporting posts 151 of the bottom plate 15 and another end connecting the key-cap 113 respectively for being pressed by the user with better touch feeling.

In the present embodiment, in order to allow the user being able to operate the keyboard 10 for inputting instructions or data at a place with insufficient light, the lower conductive sheet electrode 14 and the upper conductive sheet electrode 13, which fit with the supporting posts 151 of the bottom plate 15 successively, act as electrodes of the semiconductor light emitting components 12. Thus, the lower conductive sheet electrode 14 and the upper conductive sheet electrode 13 are connected to a power source, and the semiconductor light emitting components 12 are actuated with the power source directly to perform the function of light emitting. Hence, the features of the keyboard 10 such as thinness, uniform brightness, and simplified structure and manufacturing process can be achieved effectively.

The upper conductive sheet electrode 13 is a copper foil, tin foil or aluminum foil which is attached with an insulation layer 131 respectively, and the insulation layer 131 isolates the lower conductive sheet electrode 14 disposed under the upper conductive sheet electrode 13. The lower conductive sheet electrode 14 may be a copper foil, tin foil or aluminum foil with an insulation layer 141 as well. Of course, persons skilled in the art know that the lower conductive sheet electrode 14 can be a copper foil, tin foil or aluminum foil without an insulation layer 141 in case of the bottom plate 15 being made of non-metallic material such as hard plastics.

As the figures illustrate, the upper conductive sheet electrode 13 is disposed between the button key circuit set 11 and the lower conductive sheet electrode 14; the upper conductive sheet electrode 13 provides multiple through holes 132 passing through the insulation layer 131 and corresponding to the peripheries of the sensing electrode pairs 115. The semiconductor light emitting components 12 are attached to and electrically connected to the lower conductive sheet electrode 14 at areas exposed via the through holes 132 and the upper conductive sheet electrode 13 at areas near the through holes 132 respectively such that the lower conductive sheet electrode 14 and the upper conductive sheet electrode 13 are the electrodes to actuate the semiconductor light emitting components 12 to generate luminance respectively.

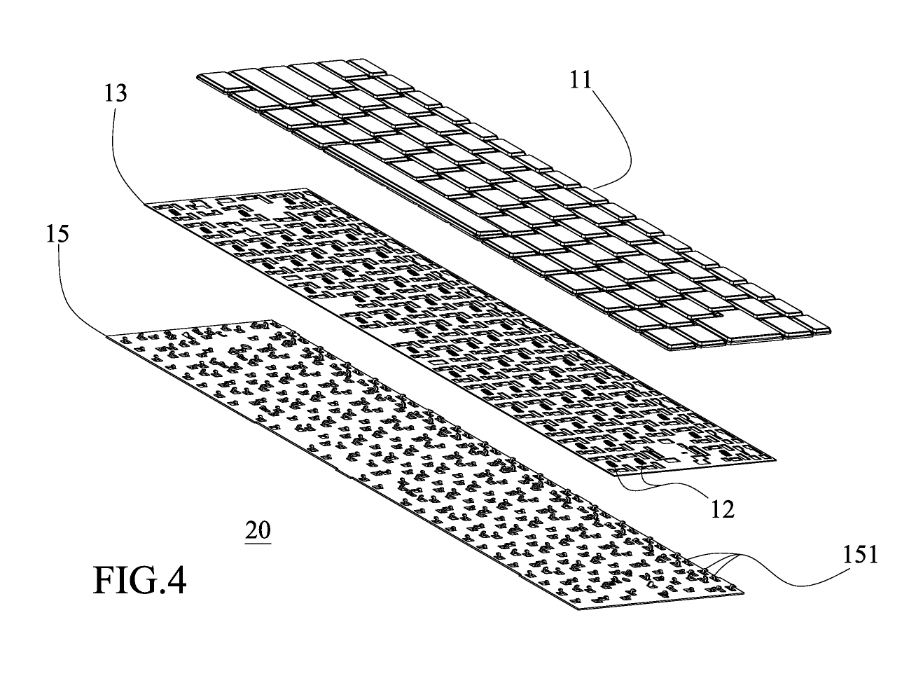

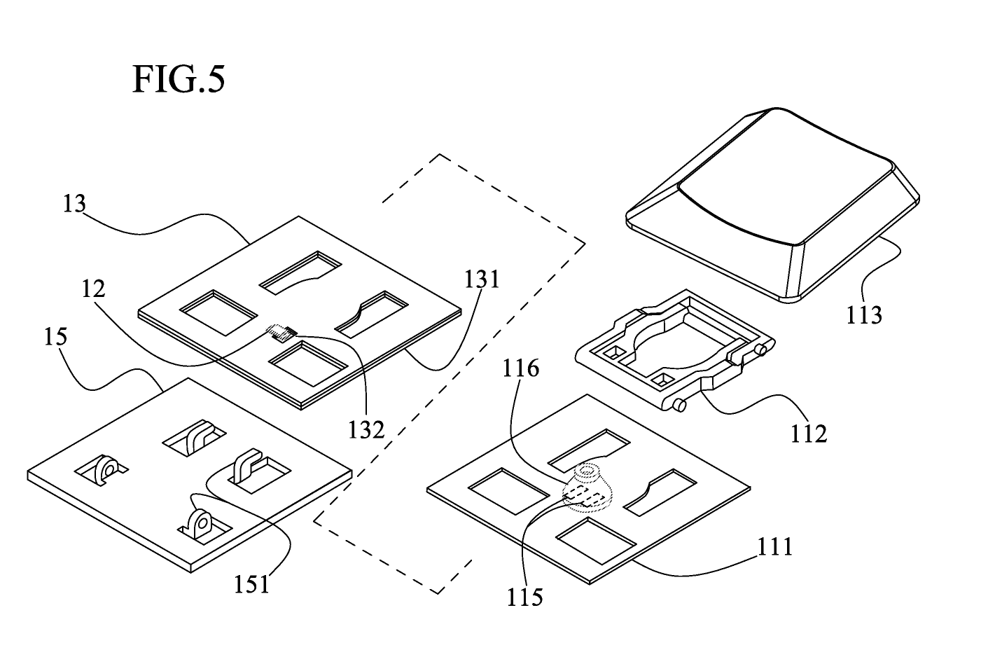

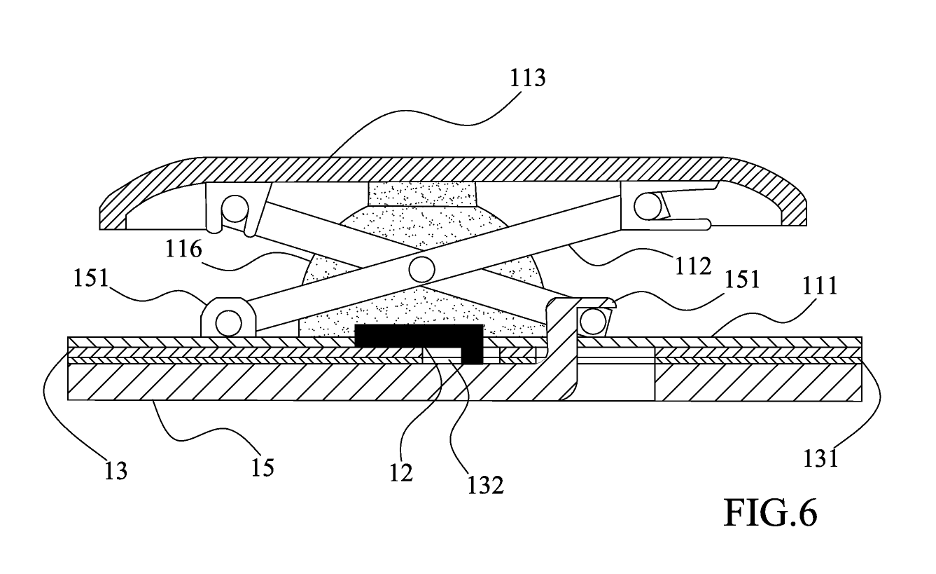

Referring to FIGS. 4 to 6, the second embodiment of a keyboard with lighting source according to the present invention are illustrated. Similarly, the keyboard 20 comprises a button key circuit set 11, multiple semiconductor light emitting components 12, an upper conductive sheet electrode 13, and a bottom plate 15 as shown in FIGS. 1-3. Nevertheless, in order to thin and simplify structure of the keyboard 20, the bottom plate 15 acts as the lower conductive sheet electrode of the semiconductor light emitting components 12 directly such that the lower conductive sheet electrode 14 shown in FIGS. 1 to 3 is omitted. The upper conductive sheet electrode 13 is still the copper foil, the tin foil or aluminum foil attached with the insulation layer 131 in order for the semiconductor light emitting components 12 being actuated to generate emission of light. The bottom plate 15 in the second embodiment has to be made of conductive metal or conductive non-metal material.

In the previous embodiments, the upper conductive sheet electrode 13 and lower conductive sheet electrode 14 (or the bottom plate 15) are an entire piece of copper foil, tin foil or aluminum foil such that the way to actuate the semiconductor light emitting components 12 to emit light is that all the semiconductor light emitting components 12 are lit up or out instead of part of the semiconductor light emitting components 12 being lit up or out. If it is required to light up local areas of the keyboard, the upper conductive sheet electrode 13 and lower conductive sheet electrode 14 can be further divided into several zones based on needs, or a layer or multiple layers of additional conductive sheet electrodes are added in addition to the upper conductive sheet electrode 13 and lower conductive sheet electrode 14. Then, the semiconductor light emitting components 12 are electrically connected to different conductive sheet electrodes according to the demand. As a result, the semiconductor light emitting components 12 can be lit up at different time intervals and different areas under control.

While the invention has been described with referencing to the preferred embodiments thereof, it is to be understood that modifications or variations may be easily made without departing from the spirit of this invention, which is defined by the appended claims.

What is claimed is:

1. A keyboard with lighting source comprising:
a button key circuit set;
a lower conductive sheet electrode;
an upper conductive sheet electrode disposed between the button key circuit set and the lower conductive sheet electrode, having an insulation layer to isolate the lower conductive sheet electrode and a plurality of through holes passing through the insulation layer; and
a plurality of semiconductor light emitting components being attached to and electrically connected to the lower conductive sheet electrode at areas exposed with the through holes, and being attached to and electrically connected to the upper conductive sheet electrode at areas next to the through holes.

2. The keyboard with lighting source as defined in claim 1, wherein the upper conductive sheet electrode is a foil made of copper, tin or aluminum attached with the insulation layer, and the lower conductive sheet electrode is a bottom plate made of metal.

3. The keyboard with lighting source as defined in claim 1, wherein the upper conductive sheet electrode is a foil made of copper, tin or aluminum attached with the insulation layer, the lower conductive sheet electrode is a foil made of copper, tin or aluminum, and a bottom plate is disposed at a side of the lower conductive sheet electrode apart from the upper conductive sheet electrode.

4. The keyboard with lighting source as defined in claim 2, wherein the button key circuit set further comprises:
a film circuit board next to the upper conductive sheet electrode, having a plurality of sensing electrode pairs and a plurality of elastic press buttons corresponding to the sensing electrode pairs;
a plurality of scissors with an end of the respective scissor pivotally connecting with the bottom plate, being disposed at circumferences of the elastic press buttons respectively; and
a plurality of key caps connecting with another end of the respective scissor, being disposed on the elastic press buttons respectively.

5. The keyboard with lighting source as defined in claim 3, wherein the button key circuit set further comprises:
a film circuit board next to the upper conductive sheet electrode, having a plurality of sensing electrode pairs and a plurality of elastic press buttons corresponding to the sensing electrode pairs;
a plurality of scissors with an end of the respective scissor pivotally connecting with the bottom plate, being disposed at circumferences of the elastic press buttons respectively; and
a plurality of key caps connecting with another end of the respective scissor, being disposed on the elastic press buttons respectively.

6. The keyboard with lighting source as defined in claim 4, wherein the through holes are disposed at the peripheries of the sensing electrode pairs respectively.

7. The keyboard with lighting source as defined in claim 5, wherein the through holes are disposed at the peripheries of the sensing electrode pairs respectively

8. The keyboard with lighting source as defined in claim 1, wherein the semiconductor light emitting components are light emitting diodes.
